(19) United States
(12) Patent Application Publication
(10) Pub. No.: US 2011/0113330 A1
(43) Pub. Date: May 12, 2011

(54) METHOD FOR SETTING UP A LIST OF AUDIO FILES

(75) Inventors: Jonas Olsson, Helsingborg (SE); Linda Meiby, Malmo (SE)

(73) Assignee: SONY ERICSSON MOBILE COMMUNICATIONS AB, Lund (SE)

(21) Appl. No.: 12/613,799

(22) Filed: Nov. 6, 2009

(51) Int. Cl. G06F 3/00

(52) U.S. Cl. 715/716

(57) ABSTRACT

A method for setting up a list of audio files to be played back by a mobile device when traveling along a route, and a mobile device utilizing the method for setting up the list of audio files are described.

### BACKGROUND OF THE INVENTION

The present invention relates to a method for setting up a list of audio files to be played back by a mobile device when traveling along a route, and a mobile device utilizing the method for setting up the list of audio files.

### BRIEF SUMMARY OF THE INVENTION

According to an embodiment, a method for setting up a list of audio files is provided. The audio files of the list are to be played back by a mobile device when the mobile device is traveling along a route. According to the method, the route which comprises a plurality of sections is determined. For each section of the route a slope of the section is automatically determined, and furthermore depending on the slope of the section, for each section of the route an audio file is automatically selected among a plurality of audio files. The selected audio files are automatically arranged in the list of audio files in an order corresponding to an order of the sections of the route, that is to say, the order in which the sections of the route are passed when the mobile device is traveling along the route.

Selecting the audio files may comprise a determination of a tempo, defined e.g. by a number of beats per minute, depending on the determined slope and a selection of an audio file providing the determined tempo. Furthermore, the audio file may be selected based on a determination of a genre depending on the determined slope and a selection of an audio file providing the determined genre.

When a user of the mobile device is planning an outdoor activity, for example walking, running, jogging, hiking or biking, the user may plan the route along which the user is planning to travel and may want to listen to music from a mobile device while traveling. By utilizing the above-described embodiment of the method of the present invention, a list of audio files, a so-called playlist, can be automatically set up which is adapted to the topographic characteristic of the planned route. The audio files of the list of audio files may be then played back while the user is traveling along the route. Thus, for example during an uphill movement of the user, an uptempo song may be played to motivate the user whereas during a downhill passage of the route an audio file containing slower music may be played back to keep the pace on a selected or wanted speed.

According to an embodiment, a plurality of slope ranges may be defined and the sections of the route may be automatically determined such that each section comprises only one of the plurality of slope ranges. The plurality of slope ranges may comprise a first slope range comprising ascending slopes, a second slope range comprising descending slopes, and a third slope range comprising approximately flat slopes. Therefore, audio files for each section can be easily selected depending on the slope range of the section. As described above, for example, for ascending slopes an uptempo or faster song can be selected to motivate the user, for descending slopes an audio file with slower music may be selected, and for approximately flat slopes music having a midrange tempo may be selected. Additionally or as an alternative the genre of the plurality of audio files may be considered.

According to another embodiment, the route may be defined on a topographic electronic map and the slope of each section of the route may be determined automatically from altitude data of the topographic electronic map.

According to an embodiment, the method may further comprise playing back the audio files according to the list of audio files, and determining automatically a current position of the mobile device. Depending on the determined current position the list of audio files may be automatically updated or adapted.

According to another embodiment, a mobile device is provided. The mobile device comprises a processing unit having access to a plurality of audio files. The processing unit is adapted to determine for each section of a route along which the mobile device is moving a slope of the section of the route. Furthermore, the processing unit is adapted to select among the plurality of audio files for each section of the route an audio file depending on the slope of the section, and to arrange the selected audio files in a list of audio files, a so-called playlist, in an order corresponding to an order of the sections of the route.

For gaining access to the plurality of audio files, the processing unit may comprise a memory for storing audio files within the mobile device or the processing unit may be coupled to a data communication network providing in e.g. a server of the data communication network audio files which may be accessible by the processing unit.

The mobile device may be a mobile phone, a personal digital assistant, a mobile navigation system, a mobile music player such as an MP3-player, or a mobile computer.

According to another embodiment, a method for selecting an audio file to be played back by a mobile device is provided. The method comprises an automatic determination of a slope of a route along which the mobile device is moving, and an automatic selection of an audio file among a plurality of audio files depending on the determined slope.

For selecting the audio files a tempo may be determined depending on the determined slope, and the audio file may be selected such that the selected audio file provides the determined tempo.

Furthermore, a genre may be determined depending on the determined slope and the audio file may be selected such that it provides the determined genre.

According to an embodiment, the slope is determined by determining a global position of the user and determining the slope from altitude data of a topographic electronic map and the determined global position information.

Additionally or as an alternative, the slope may be determined by determining at least two altitude values at different points in time and determining the slope depending on the difference between the at least two altitude values.

According to another embodiment, a mobile device comprising a processing unit is provided. The processing unit has access to a plurality of audio files. The processing unit is adapted to determine a slope of a route along which the mobile device is moving and to select an audio file to be played back by the mobile device from the plurality of audio files depending on the determined slope.

According to another embodiment, a method for selecting an audio file to be played back by a mobile device comprises determining automatically a heart rate of a user of the mobile device, and selecting automatically among a plurality of audio files the audio file depending on the determined heart rate.

According to an embodiment of the method for selecting the audio file comprises a determination of a tempo depending on the determined heart rate, and a selection of an audio file providing the determined tempo. Selecting the audio file may further comprise determining a genre depending on the determined heart rate and selecting an audio file providing the determined genre.

According to another embodiment a mobile device comprising a processing unit having access to a plurality of audio files is provided. The processing unit is adapted to determine a heart rate of a user of the mobile device and to select an audio file to be played back by the mobile device from the plurality of audio files depending on the determined heart rate.

According to yet another embodiment of the present invention, a further method for selecting an audio file to be played back by a mobile device comprises determining automatically the surroundings of a route along which the mobile device is moving and selecting automatically among a plurality of audio files the audio file depending on the determined surroundings. The surroundings may be determined based on data of an electronic map, pictures or videos taking by the mobile device, or acoustic sounds received from an environment of the mobile device and analyzed by the mobile device.

The audio file may be selected based on a determination of a tempo depending on the determined surroundings such that the selected audio file provides the determined tempo.

Selecting the audio file may also comprise determining a genre depending on the determined surroundings and selecting an audio file providing the determined genre.

Finally, according to another embodiment, a mobile device comprising a processing unit is provided. The processing unit has access to a plurality of audio files which may be played back by the mobile device. The processing unit is adapted to determine surroundings of a route along which the mobile device is moving, and to select an audio file to be played back by the mobile device from the plurality of audio files depending on the determined surroundings.

Although specific features described in the above summary and the following detailed description are described in connection with specific embodiments, it is to be understood that the features of the embodiments described can be combined with each other unless it is noted otherwise.

### BRIEF DESCRIPTION OF THE DRAWINGS

Hereinafter, exemplary embodiments of the invention will be described with reference to the drawings.

FIG. 1 shows a mobile device according to an embodiment of the present invention.

FIG. 2 shows how audio files are selected for a list of audio files according to a method according to an embodiment of the present invention.

### DETAILED DESCRIPTION OF THE INVENTION

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise.

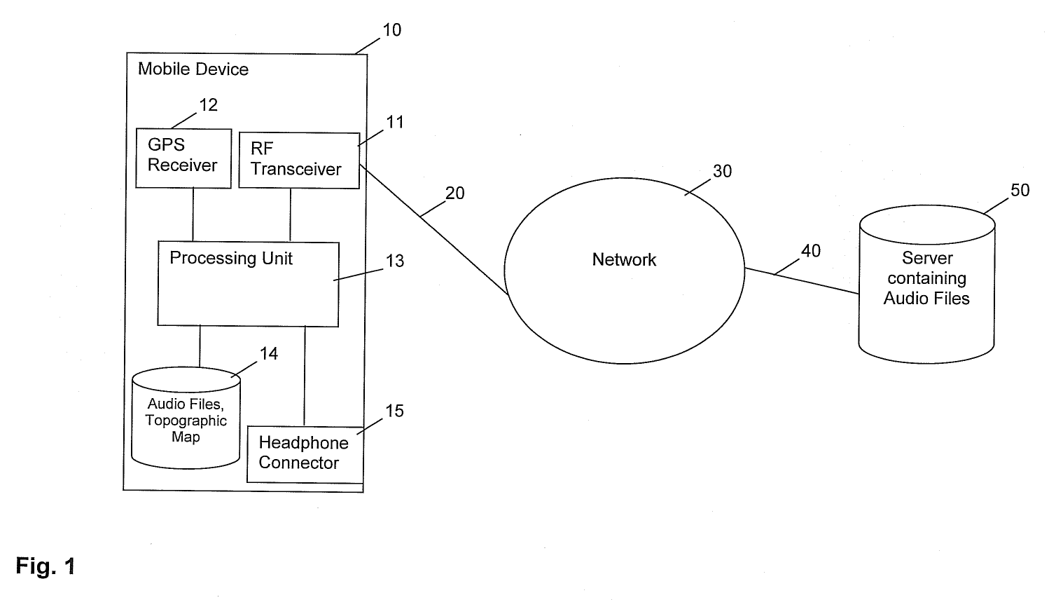

FIG. 1 shows schematically a mobile device 10 which may be connected to a server 50 via a network 30. A connection 20 between the mobile device 10 and the network 30 may be a wireless connection, for example a GSM, UMTS, GPRS or Bluetooth connection. However, connection 20 may be any other kind of wireless or wired connection. Connection 40 between the network 30 and the server 50 may be also any kind of wireless or wired connection.

The mobile device 10 comprises a radio frequency transceiver 11, a GPS receiver 12, a processing unit 13, a memory 14 and a headphone connector 15. Additionally, the mobile device 10 may comprise additional components, for example a display, a keypad, a loudspeaker, a microphone and so on, but these components are not shown in FIG. 1 to simplify matters. The processing unit 13 is connected to the radio frequency transceiver 11, the GPS receiver 12, the headphone connector 15 and the memory 14. The GPS receiver 12 may receive signals from a global positioning system, for example GPS or Galileo, to provide a positioning information of the mobile device 10. The radio frequency transceiver 11 may utilize a data communication between the processing unit 13 and the server 50 via a wireless connection 20 and a data communication network 30. The memory 14 may be used to store a plurality of audio files which may be played back by the processing unit 13 as audio data which may be output via the headphone connector 15. Furthermore, the memory 14 may be used for storing an electronic topographic map.

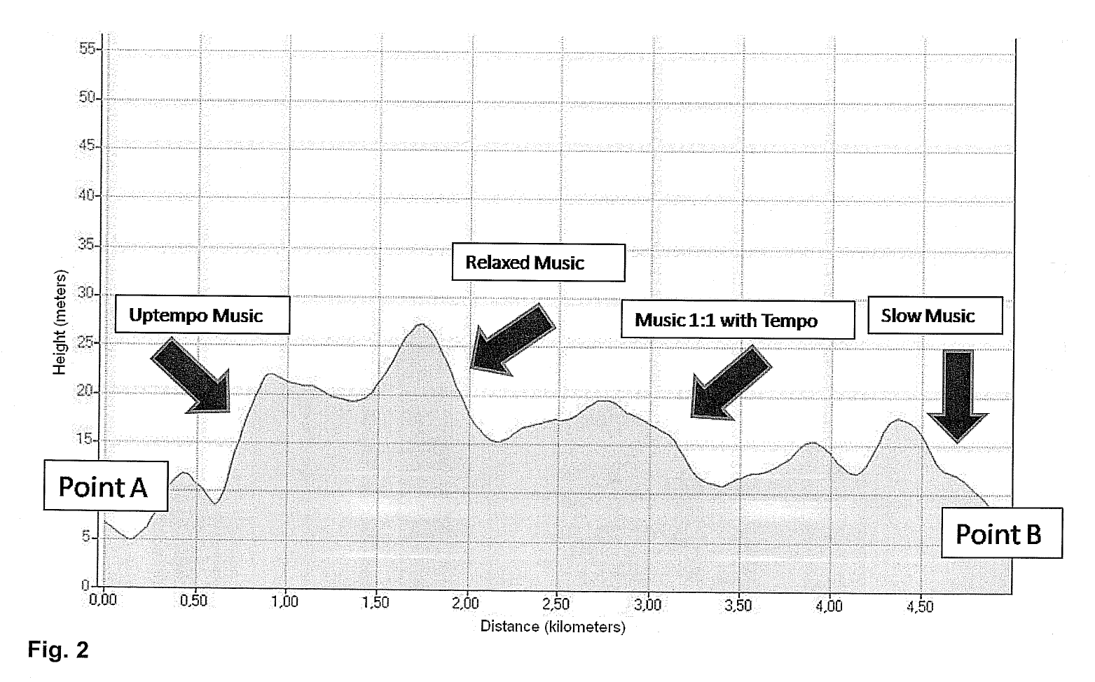

Operation of the processing unit 13 will now be described in more detail in connection with FIG. 1 and FIG. 2.

Assuming a user of the mobile device 10 wants to do some outdoor activity, for example hiking, walking, running, or biking, the user may plan a route along which the user wants to travel with the help of the electronic map provided in memory 14 of the mobile device 10. Planning the route may be supported by the processing unit 13 by performing a routing from a user-defined starting point to a user-defined end point. Furthermore, the processing unit may retrieve via the network 30 from an appropriate server 50 a predefined route, for example a predefined hiking route or a predefined biking route in the mountains. Based on the determined route, the processing unit 13 determines an altitude profile based on for example topographic data of the map in the memory 14 or based on topographic data retrieved via network 30 from a server 50.

FIG. 2 shows such an altitude profile for a route starting at point A and ending at point B. The altitude of the route is plotted along the distance of the route with the distance of the route shown on the abscissa and the altitude of the route shown on the ordinate.

The processing unit 13 divides the route into a plurality of sections such that each section provides substantially either an ascending slope, a descending slope, or an approximately flat slope. Furthermore, the user may input into the mobile device an estimated average speed the user will travel along the route. From the length of each section and the estimated speed, which may be adapted depending on the slope, the processing unit 13 determines for each section a duration. Then, the processing unit 13 selects for each section among a plurality of audio files an audio file depending on the slope of the section. E.g., the processing unit 13 may select for ascending sections an audio file with a high tempo, for a section with a flat slope an audio file with a midrange tempo, and for a section with a descending slope a slow tempo audio file. The selected audio files are then arranged by the processing unit 13 in a list of audio files in an order corresponding to the order of the sections of the route. If a section has a duration longer than the selected audio file, a further audio file for this section may be inserted into the list of audio files. Furthermore, for each audio file a playing time may be stored in the list of audio files to interrupt or fade out the audio file before the end of the audio file, if the corresponding section duration is shorter than the length of the audio file.

FIG. 2 shows the above-described example in more detail. The determined route has a length of approximately 5 km. From the starting point A at kilometer zero to approximately kilometer 1.7 the route is substantially ascending. Therefore, for this section one or more audio files with uptempo music are arranged in the list of audio files, the so-called playlist. For the next section of the route, starting at kilometer 1.7 and ending at kilometer 2.2, slower music or relaxed music is selected as the next audio file for the playlist.

Thus, during the ascending section of the route the user is motivated by the uptempo music, whereas in the second section the user is calmed down to keep the pace slow when moving downhill.

The next section starting at kilometer 2.2 and ending at kilometer 4.4 is approximately flat with small ascending and descending parts and therefore one or more audio files with a midrange tempo may be selected to be arranged for this section in the playlist. However, this section may also be divided into further sub-sections taking into account the slope of the sub-sections. Finally, for the last section starting at kilometer 4.4 and ending at point B, an audio file with slow music is selected for the playlist, as the slope of the route is descending in this section.

For determining a tempo and/or genre of an audio file, the audio file can be analysed in a wide variety of ways. For example by using a mathematical analysis the tempo can be extracted as a low complexity feature. Combining a number of low complexity features like tempo and genre will provide high complexity features like for example a mood of the music, e.g. happy or sad. Therefore, the audio file may be tagged with metadata representing a combination of tempo, style of the music, acoustic/electronic or genre like jazz, rock etc.

The above-described mobile device provides the user with playlists that fit to a route or track the user is moving along. The playlists may comprise music of audio files stored in memory 14 of the mobile device 10 or music which may be downloaded or streamed from the server 50. For downloading or streaming music from the server 50, the user may be prompted in advance.

While exemplary embodiments have been described above, various modifications may be implemented in other embodiments. For example, when the user starts running, the GPS receiver 12 may be started to determine the exact position on the route. If the user suddenly breaks off the route, goes back, starts walking or the like, the playlist may be automatically readjusted to fit to the profile and the current position based on the GPS information. Therefore, audio files may be added or removed from the playlist dynamically. Furthermore, instead of the GPS receiver 12, a barometer may be used to measure the current altitude and to determine a current slope to select music with an appropriate tempo or genre depending on the determined slope. Additionally, to ensure that the selected audio files are liked by the user, user preferences or audio files that have been played back in the past may be automatically considered by the processing unit 13 when selecting audio files for the playlist.

Furthermore, the mobile device may be adapted to determine a heart rate of the user, for example by using a pulse monitor, for example an infrared pulse meter integrated in a headset to measure the pulse at an ear of the user or an EKG-meter. The playlist may be adapted by the processing unit taking into account the pulse of the user to energize or calm down the user. For example, energizing music may be used during a warm-up period or to accelerate the pulse before a forthcoming hill and calming music may be used to ensure to slow down the pulse when there is a pause between heavy hills.

Moreover, the profile of a route as whole may be considered for selecting music for the playlist: for example, after a long ascending section, an audio file with a lower tempo may be inserted to ensure recovery of the user, whereas after a short ascending section this may not be necessary. Furthermore, in case of a long approximately flat section, the tempo of the audio files may be varied to vary the motivation and to avoid the user getting bored.

Furthermore, by using a compass of the mobile device in conjunction with the above described method, different lists of audio files or playlists can be suggested to the user by simply pointing the device in various directions. Thus, the mobile device quickly informs the user about the typical profile of the route laying ahead of the user. Even if the route is not a straight line from a bird's eye view, this may still serve as a guideline to the user. For instance if the route ahead is relatively flat, the music may be somehow laid back but not relaxing nor energetic. If the route ahead is rather steep like a mountain trail, the music may be highly energetic. A short pre-listening to the playlist in conjunction with pointing in various directions will give the user a quick advice on the topographic profile ahead. The above could be used in terms of a starting point for a route selection when the user is standing at a cross road but it may also be used dynamically telling the user with some pre-warning how the user should spend the users energy and effort, for instance when riding with a bicycle along a route with parts of the route going upwards and parts of the route going downhill. This can be used to optimize energy consumption during the travel. As a compass is becoming standard in mobile devices such as a mobile phones, this is can be realised cost efficient.

Moreover, the above described method can also be used in combination sport equipment in a gym or at home, e.g. a treadmill, a bicycle ergometer or a rowing machine ergometer. In this case the route is not an outdoor topographic path but a track profile or an intensity profile on the sport equipment. This type of equipment may provide a graphical representation of a selected track profile with elevations, declinations and different speed or intensity profiles. This track is determined as the route in the method of the invention, and based on this track an adapted playlist can be set up, thus supporting the training exercise and optimizing the user experience as well as the physical exchange since music is known to have both psychological as well as pure physical effects on heart rate and stamina for the user. The mobile device may serve as playback device and playlist compilation unit in conjunction with the sport equipments representation of the track profile. For example, using a step counter, an accelerometer and/or a gyro, the mobile device itself could change music based on the speed and elevation of for example a treadmill.

Finally, it is to be understood that all the embodiments described above are considered to be comprised by the present invention as it is defined by the appended claims.

What is claimed is:

1. A method for setting up a list of audio files to be played back by a mobile device when traveling along a route, the method comprising:
determining the route having a plurality of sections,
determining automatically for each section of the route a slope of the section of the route,
selecting automatically among a plurality of audio files for each section of the route an audio file depending on the slope of the section, and
arranging automatically the selected audio files in the list of audio files in an order corresponding to the order of the sections of the route.

2. The method according claim 1, wherein selecting the audio file comprises determining a tempo depending on the determined slope and selecting an audio file providing the determined tempo.

3. The method according claim 1, wherein selecting the audio file comprises determining a genre depending on the determined slope and selecting an audio file providing the determined genre.

4. The method according claim 1, further comprising:
defining a plurality of slope ranges, and
determining the sections of the route automatically such that each section comprises only one of the plurality of slope ranges.

5. The method according claim 4, wherein the plurality of slope ranges comprise a first slope range comprising ascending slopes, a second slope range comprising descending slopes, and a third slope range comprising approximately flat slopes.

6. The method according claim 1, wherein the route is defined on an topographic electronic map and the slope of each section of the route is determined automatically from altitude data of the topographic electronic map.

7. The method according claim 1, further comprising:
playing back the audio files according to the list of audio files,
determining automatically a current position of the mobile device, and
updating automatically the list of audio files depending on the current position.

8. A mobile device comprising a processing unit having access to a plurality of audio files, wherein the processing unit is adapted to:
determine for each section of a route along which the mobile device is moving a slope of the section of the route,
select among the plurality of audio files for each section of the route an audio file depending on the slope of the section, and
arrange the selected audio files in a list of audio files in an order corresponding to the order of the sections of the route.

9. The mobile device according to claim 8, wherein the mobile device comprises a device selected from the group comprising a mobile phone, a personal digital assistant, a mobile navigation system, a mobile music player and a mobile computer.

10. A method for selecting an audio file to be played back by a mobile device, the method comprising:
determining automatically a slope of a route along which the mobile device is moving, and
selecting automatically among a plurality of audio files the audio file depending on the determined slope.

11. The method according claim 10, wherein selecting the audio file comprises determining a tempo depending on the determined slope and selecting an audio file providing the determined tempo.

12. The method according claim 10, wherein selecting the audio file comprises determining a genre depending on the determined slope and selecting an audio file providing the determined genre.

13. The method according claim 10, wherein determining the slope comprises:
determining a global position of the user, and
determining the slope from altitude data of a topographic electronic map and the global position information.

14. The method according claim 10, wherein determining the slope comprises:
determining at least two altitude values at different points in time, and
determining the slope depending on the difference between the at least two altitude values.

15. A mobile device comprising a processing unit having access to a plurality of audio files, wherein the processing unit is adapted to:
determine a slope of a route along which the mobile device is moving, and
select an audio file to be played back by the mobile device from the plurality of audio files depending on the determined slope.

16. The mobile device according to claim 15, wherein the mobile device comprises a device selected from the group comprising a mobile phone, a personal digital assistant, a mobile navigation system, a mobile music player and a mobile computer.

17. A method for selecting an audio file to be played back by a mobile device, the method comprising:
determining automatically a heart rate of a user of the mobile device, and
selecting automatically among a plurality of audio files the audio file depending on the determined heart rate.

18. The method according claim 17, wherein selecting the audio file comprises determining a tempo depending on the determined heart rate and selecting an audio file providing the determined tempo.

19. The method according claim 17, wherein selecting the audio file comprises determining a genre depending on the determined heart rate and selecting an audio file providing the determined genre.

20. A mobile device comprising a processing unit having access to a plurality of audio files, wherein the processing unit is adapted to:
determine a heart rate of a user of the mobile device, and
select an audio file to be played back by the mobile device from the plurality of audio files depending on the determined heart rate.

21. The mobile device according to claim 20, wherein the mobile device comprises a device selected from the group comprising a mobile phone, a personal digital assistant, a mobile navigation system, a mobile music player and a mobile computer.

22. A method for selecting an audio file to be played back by a mobile device, the method comprising:
determining automatically surroundings of a route along which the mobile device is moving, and
selecting automatically among a plurality of audio files the audio file depending on the determined surroundings.

23. The method according claim 22, wherein selecting the audio file comprises determining a tempo depending on the determined surroundings and selecting an audio file providing the determined tempo.

24. The method according claim 22, wherein selecting the audio file comprises determining a genre depending on the determined surroundings and selecting an audio file providing the determined genre.

25. A mobile device comprising a processing unit having access to a plurality of audio files, wherein the processing unit is adapted to:
determine surroundings of a route along which the mobile device is moving, and
select an audio file to be played back by the mobile device from the plurality of audio files depending on the determined surroundings.

26. The mobile device according to claim 25, wherein the mobile device comprises a device selected from the group comprising a mobile phone, a personal digital assistant, a mobile navigation system, a mobile music player and a mobile computer.
